(19) United States
(12) Patent Application Publication
(10) Pub. No.: US 2014/0258680 A1
(43) Pub. Date: Sep. 11, 2014

(54) PARALLEL DISPATCH OF COPROCESSOR INSTRUCTIONS IN A MULTI-THREAD PROCESSOR

(71) Applicant: QUALCOMM INCORPORATED, San Diego, CA (US)

(72) Inventors: Ajay Anant Ingle, Austin, TX (US); Lucian Codrescu, Austin, TX (US); Suresh K. Venkumahanti, Austin, TX (US); Jose Fridman, Waban, MA (US)

(73) Assignee: QUALCOMM INCORPORATED, San Diego, CA (US)

(21) Appl. No.: 13/785,017

(22) Filed: Mar. 5, 2013

(51) Int. Cl. G06F 9/38

(52) U.S. Cl. CPC G06F 9/38
USPC 712/205

(57) ABSTRACT

Techniques are addressed for parallel dispatch of coprocessor and thread instructions to a coprocessor coupled to a threaded processor. A first packet of threaded processor instructions is accessed from an instruction fetch queue (IFQ) and a second packet of coprocessor instructions is accessed from the IFQ. The IFQ includes a plurality of thread queues that are each configured to store instructions associated with a specific thread of instructions. A dispatch circuit is configured to select the first packet of thread instructions from the IFQ and the second packet of coprocessor instructions from the IFQ and send the first packet to a threaded processor and the second packet to the coprocessor in parallel. A data port is configured to share data between the coprocessor and a register file in the threaded processor. Data port operations are accomplished without affecting operations on any thread executing on the threaded processor.

### FIELD OF THE DISCLOSURE

The present disclosure relates generally to the field of multi-thread processors and in particular to efficient operation of a multi-thread processor coupled to a coprocessor.

### BACKGROUND

Many portable products, such as cell phones, laptop computers, personal data assistants (PDAs) and the like, utilize a processing system that executes programs, such as communication and multimedia programs. A processing system for such products may include multiple processors, multi-thread processors, complex memory systems including multi-levels of caches for storing instructions and data, controllers, peripheral devices such as communication interfaces, and fixed function logic blocks configured, for example, on a single chip.

In multiprocessor portable systems, including smartphones, tablets, and the like, an applications processor may be used to coordinate operations among a number of embedded processors. The application processor may use multiple types of parallelism, including instruction level parallelism (ILP), data level parallelism (DLP), and thread level parallelism (TLP). ILP may be achieved through pipelining operations in a processor, by use of very long instruction word (VLIW) techniques, and through super-scalar instruction issuing techniques. DLP may be achieved through use of single instruction multiple data (SIMD) techniques such as packed data operations and use of parallel processing elements executing the same instruction on different data. TLP may be achieved a number of ways including interleaved multi-threading on a multi-threaded processor and by use of a plurality of processors operating in parallel using multiple instruction multiple data (MIMD) techniques. These three forms of parallelism may be combined to improve performance of a processing system. However, combining these parallel processing techniques is a difficult process and may cause bottlenecks and additional complexities which reduce potential performance gains. For example, mixing different forms of TLP in a single system using a multi-threaded processor with a second independent processor, such as a specialized coprocessor, may not achieve the best performance from either processor.

### SUMMARY

Among its several aspects, the present disclosure recognizes that it is advantageous to provide more efficient methods and apparatuses for operating a multi-threaded processor with an attached specialized coprocessor. To such ends, an embodiment of the invention addresses a method for parallel dispatch of coprocessor instructions to a coprocessor and threaded processor instructions to a threaded processor. A first packet of threaded processor instructions is accessed from an instruction fetch queue (IFQ). A second packet of coprocessor instructions is accessed from the IFQ. The first packet is dispatched to the threaded processor and the second packet is dispatched to the coprocessor in parallel.

Another embodiment addresses an apparatus for parallel dispatch of coprocessor instructions to a coprocessor and threaded processor instructions to a threaded processor. An instruction fetch queue (IFQ) comprises a plurality of thread queues that are configured to store instructions associated with a specific thread of instructions. A dispatch circuit is configured for selecting a first packet of thread instructions from the IFQ and a second packet of coprocessor instructions from the IFQ and sending the selected first packet to a threaded processor and the selected second packet to the coprocessor in parallel.

Another embodiment addresses a method for parallel dispatch of coprocessor instructions to a coprocessor and threaded processor instructions to a threaded processor. A first packet of instructions is fetched from a memory, wherein the fetched first packet contains at least one threaded processor instruction and at least one coprocessor instruction. The at least one threaded processor instruction is split from the fetched first packet as a threaded processor instruction packet. The at least one coprocessor instruction is split from the fetched first packet as a coprocessor instruction packet. The threaded processor instruction packet is dispatched to the threaded processor and in parallel the coprocessor instruction packet is dispatched to the coprocessor.

Another embodiment addresses an apparatus for parallel dispatch of coprocessor instructions to a coprocessor and threaded processor instructions to a threaded processor comprising a memory from which a packet of instructions is fetched, wherein the packet contains at least one threaded processor instruction and at least one coprocessor instruction. A store thread selector (STS) is configured to receive the packet of instructions, determine a header indicating type of instructions that comprise the packet, and store the instructions from the packet and the header in an instruction queue. A dispatch unit is configured to select the threaded processor instruction and send the threaded processor instruction to the threaded processor and in parallel select the coprocessor instruction and send the coprocessor instruction to the coprocessor.

Another embodiment addresses a computer readable non-transitory medium encoded with computer readable program data and code. A first packet of threaded processor instructions is accessed from an instruction fetch queue (IFQ). A second packet of coprocessor instructions is accessed from the IFQ. The first packet is dispatched to the threaded processor and the second packet is dispatched to the coprocessor in parallel.

Another embodiment addresses an apparatus for parallel dispatch of coprocessor instructions to a coprocessor and threaded processor instructions to a threaded processor. Means is utilized for storing instructions associated with a specific thread of instructions in an instruction fetch queue (IFQ) in order for the instructions to be accessible for transfer to a processor associated with the thread. Means is utilized for selecting a first packet of thread instructions from the IFQ and a second packet of coprocessor instructions from the IFQ and sending the selected first packet to a threaded processor and the selected second packet to the coprocessor in parallel.

Another embodiment addresses a computer readable non-transitory medium encoded with computer readable program data and code. A first packet of instructions is fetched from a memory, wherein the fetched first packet contains at least one threaded processor instruction and at least one coprocessor instruction. The at least one threaded processor instruction is split from the fetched first packet as a threaded processor instruction packet. The at least one coprocessor instruction is split from the fetched first packet as a coprocessor instruction packet. The threaded processor instruction packet is dispatched to the threaded processor and in parallel the coprocessor instruction packet is dispatched to the coprocessor.

A further embodiment addresses an apparatus for parallel dispatch of coprocessor instructions to a coprocessor and threaded processor instructions to a threaded processor. Means is utilized for fetching a packet of instructions, wherein the packet contains at least one threaded processor instruction and at least one coprocessor instruction. Means is utilized for receiving the packet of instructions, determining a header indicating type of instructions that comprise the packet, and storing the instructions from the packet and the header in an instruction queue. Means is utilized for selecting the threaded processor instruction and sending the threaded processor instruction to the threaded processor and in parallel selecting the coprocessor instruction and sending the coprocessor instruction to the coprocessor.

It is understood that other embodiments of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Various aspects of the present invention are illustrated by way of example, and not by way of limitation, in the accompanying drawings, wherein:

FIG. 1 illustrates an embodiment of a general purpose thread (GPT) processor coupled to a coprocessor (GPTCoP) system that may be advantageously employed;

FIG. 2A illustrates an embodiment for a process of fetching instructions, identifying instruction packets, and loading coded instruction packets into an instruction queue for a single thread that may be advantageously employed;

FIG. 2B illustrates an embodiment for a process of fetching instructions, identifying instruction packets, and loading coded instruction packets into an instruction queue for two threads that may be advantageously employed;

FIG. 2C illustrates another embodiment for a process of fetching instructions, identifying instruction packets, and loading coded instruction packets into an instruction queue for a single thread that may be advantageously employed;

FIG. 2D illustrates another embodiment for a process of fetching instructions, identifying instruction packets, and loading coded instruction packets into an instruction queue for two threads that may be advantageously employed;

FIG. 2E illustrates an embodiment for a process of dispatching instructions to a first processor and to a second processor that may be advantageously employed; and

FIG. 3 illustrates a portable device having a GPT processor and coprocessor system that is configured to meet real time requirements of the portable device.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well known structures and components are shown in block diagram form in order to avoid obscuring the concepts of the present invention.

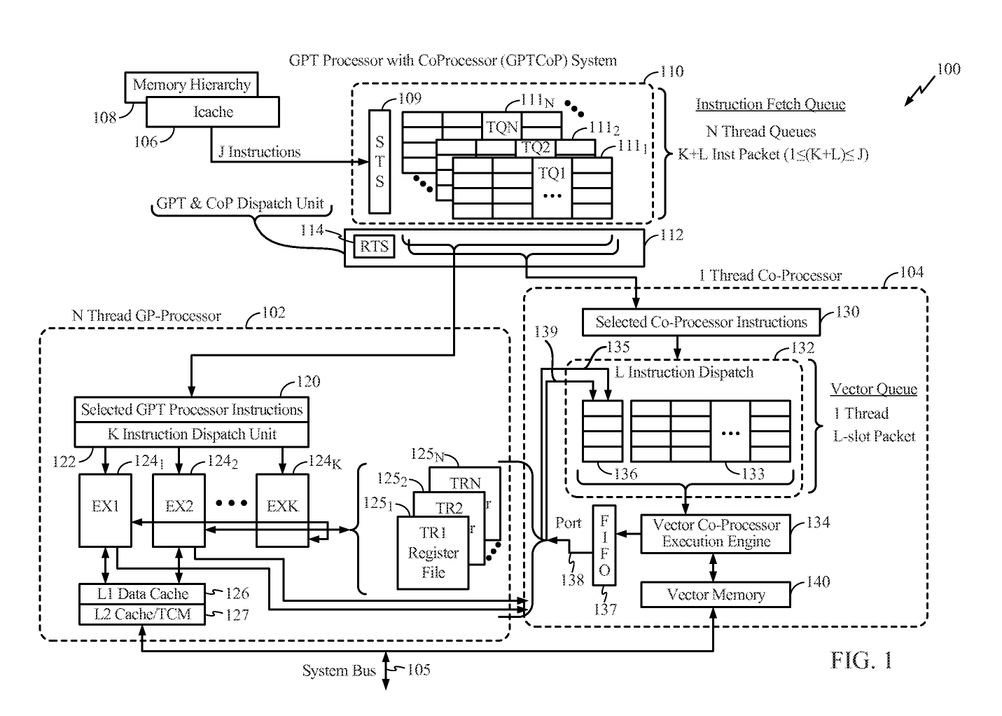

FIG. 1 illustrates an embodiment of a general purpose thread (GPT) processor coupled to a coprocessor (GPTCoP) system 100 that may be advantageously employed. The GPTCoP system 100 comprises a general purpose N thread (GPT) processor 102, a single thread coprocessor (CoP) 104, a system bus 105, an instruction cache (Icache) 106, a memory hierarchy 108, an instruction fetch queue 110, and a GPT processor and coprocessor (GPTCoP) dispatch unit 112. The memory hierarchy 108 may contain additional levels of cache such as a unified level 2 (L2) cache, an L3 cache, and a system memory.

In such an exemplary GPTCoP system 100 having a general purpose threaded (GPT) processor 102 supporting N threads coupled with a specialized coprocessor 104, the GPT processor 102 when running a program that does not require the coprocessor 104 may be configured to assign 1/N^{th} of the GPT processor's execution resources to each thread. When this exemplary system is running a program that does require the coprocessor 104, a sequential dispatching function, such as round-robin or the like, may be used that transfers GPT processor instructions to the GPT processor 102 and coprocessor instructions to the coprocessor 104 that results in assigning 1/(N+1) of the GPT processor's resources to each of the GPT processor threads.

To avoid such a significant loss in performance, the GPTCoP system 100 expands a GPT fetch queue and a GPT dispatcher that would be associated with a GPT processor without a coprocessor to the instruction fetch queue 110 and to the GPTCoP dispatch unit 112 to support both the GPT processor 102 and the CoP 104. Exemplary means are described for fetching a packet of instructions, wherein the packet contains at least one threaded processor instruction and at least one coprocessor instruction. Also, means are described for receiving the packet of instructions, determining a header indicating type of instructions that comprise the packet, and storing the instructions from the packet and the header in an instruction queue. Further, means are described for selecting the threaded processor instruction and sending the threaded processor instruction to the threaded processor and in parallel selecting the coprocessor instruction and sending the coprocessor instruction to the coprocessor. For example, the GPTCoP dispatch unit 112 dispatches a GPT processor packet in parallel with a coprocessor packet in a single GPT processor clock cycle. The instruction fetch unit 110 supports N threads for an N threaded GPT processor of which M≦N threads execute on the coprocessor and N−M threads execute on the GPT Processor. The GPTCoP dispatch unit 112 supports selecting and dispatching of a GPT packet of instructions in parallel with a coprocessor packet of instructions. The Icache 106 may support cache lines of J instructions or a plurality of J instructions, where instructions are defined as 32-bit instructions unless otherwise indicated. It is noted that variable length packets may be supported by the present invention such that with 32-bit instructions, the Icache 106 in an exemplary implementation supports up to 4*J 32-bit instructions. The GPT processor 102 supports packets of up to K GPT processor instructions (KI) and the CoP 104 supports packets of up to L CoP instructions (LI).

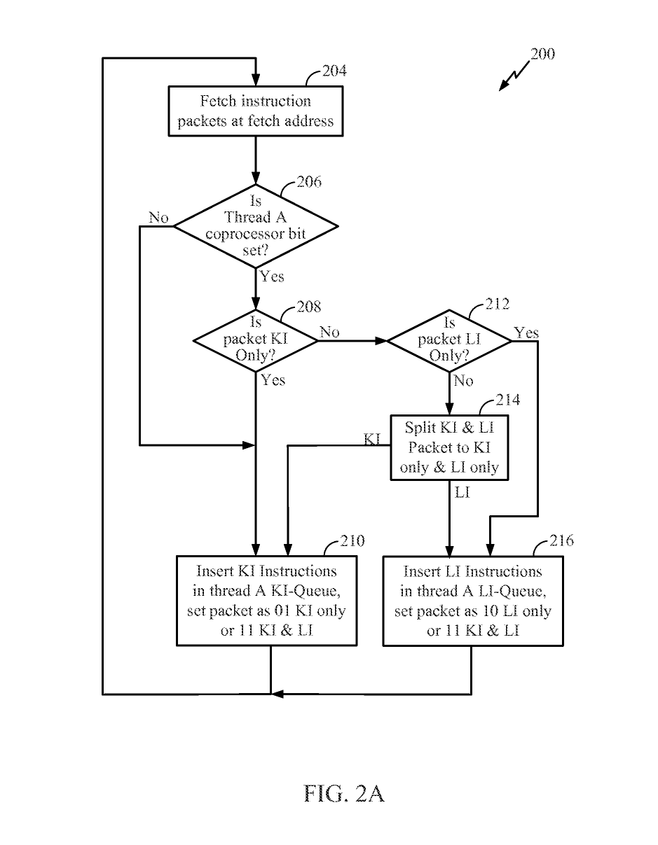

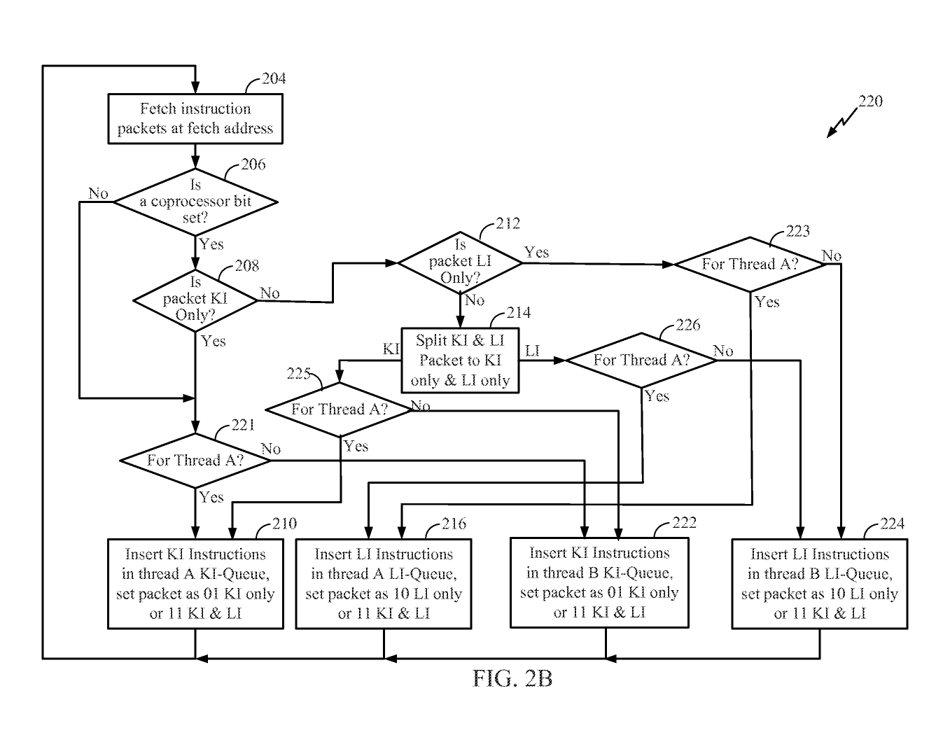

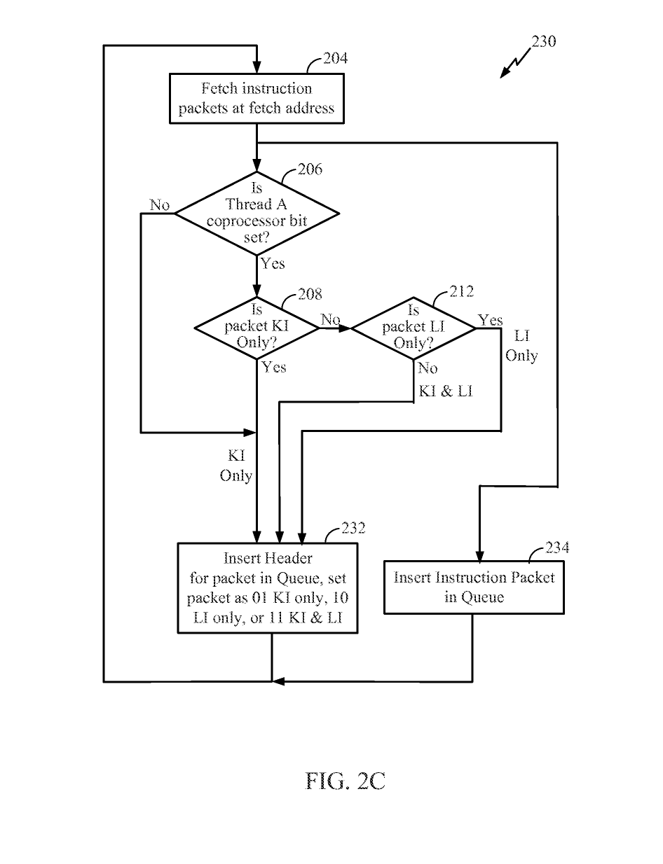

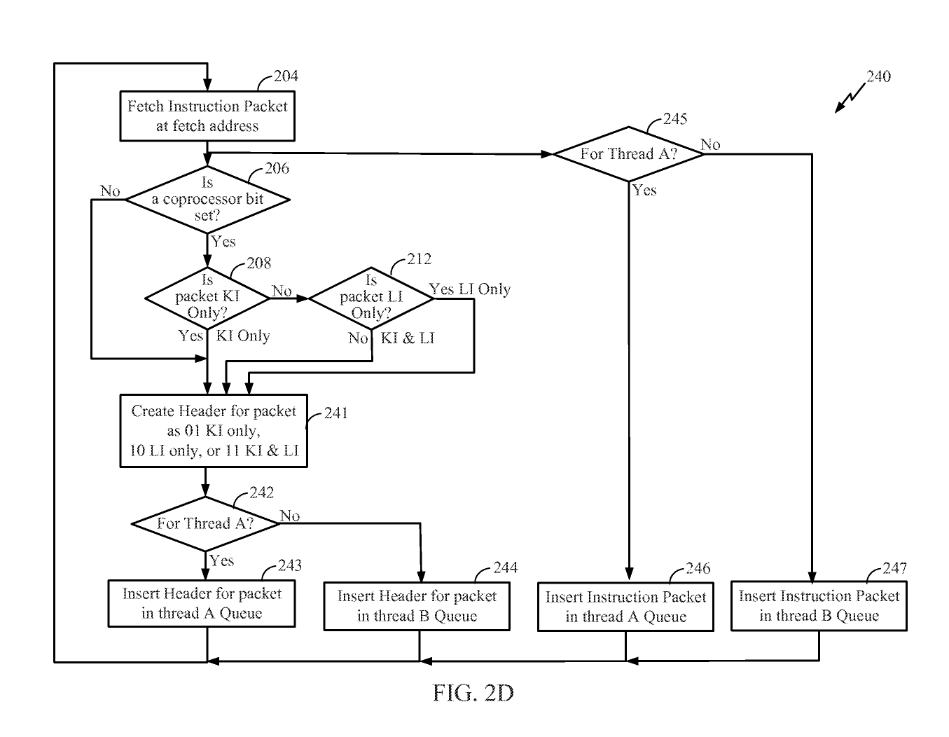

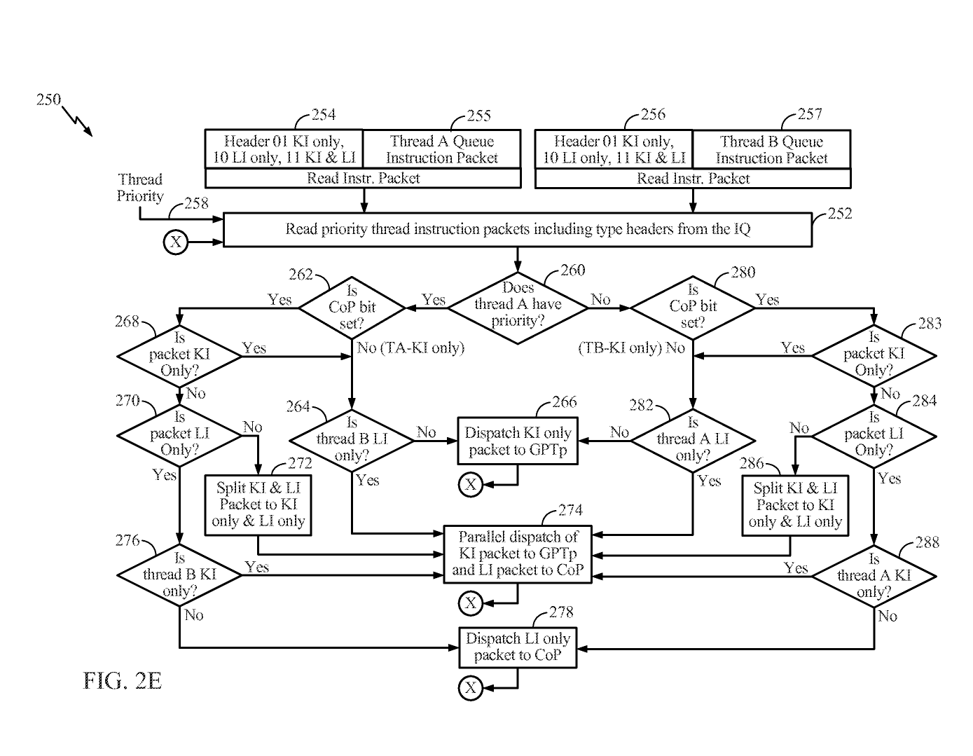

Accordingly, a combined KI packet plus an LI packet may range in size from 1 instruction to J instructions, and 1≦(K+L)≦J instructions may be simultaneously fetched and dispatched per cycle. Generally, instructions in a packet are executed in parallel. Packets may also be only KI type, with I≦K≦J instructions and with one or more KI instruction packets dispatched per cycle. The packets may also be only LI type, with 1≦L≦J instructions and with one or more LI instruction packets dispatched per cycle. For example, with K=4 and L=0 based on supported execution capacity in the GPT processor, and L=4 and K=0 based on supported execution capacity in the CoP, J would be restricted to 4 instructions. An exemplary implementation also supports dispatching of a K=4 packet and an L=4 packet in parallel, as described below in more detail with regard to FIG. 2C. Buffers to support such capacity are expected to be included in a particular design as needed based on the execution capacity of the associated processor.

The GPT processor 102 comprises a GPT buffer 120 supporting up to K selected GPT instructions per thread, an instruction dispatch unit 122 capable of dispatching up to K instructions, K execution units (Ex1-EXK) 124₁-124_{K}, N thread context register files (TR1-TRN) 125₁-125_{N}, and a level 1 (L1) data cache 126 with a backing level 2 (L2) cache tightly coupled memory (TCM) portion 127 which may be portioned into a cache portion and a TCM portion. Generally, on an instruction fetch operation, a cache line is read out on a hit in the Icache 106. The cache line may have a plurality of instruction packets and due to variable packet lengths, the last packet in the cache line can cross over to the next cache line and require another cache line fetch. Once the Icache 106 is read, the cache line is scanned to look for packets identified by a program counter (PC) address and the packet is then transferred to one of N thread queues (TQi) 111₁, 111₂,-111_{N} in the instruction fetch queue 110. A store thread selector (STS) 109 is used to select the appropriate thread queue according to a hardware scheduler and available capacity in the selected thread queue to store the packet. Each thread queue TQ1 111₁, TQ2 111₂,-TQN 111_{N} stores up to J instructions plus a packet header field, such as a 2-bit field, in each addressable storage location. For example, a 2-bit field may be decoded to define “00” reserved, “01” KI only packet, “10” LI only packet, and “11” KI & Li packet. For example, the STS 109 is used to determine the packet header. The GPTCoP dispatch unit 112 selects the up to K instructions from the selected thread queue, such as thread queue TQ1 111₁ and dispatches them to the GPT buffer 120. The instruction dispatch unit 122 then selects the up to K instructions from the GPT buffer 120 and dispatches them according to pipeline and hazard selection rules to the K execution units (Ex1-EXK) 124₁-124_{K}. According to each instruction's decoded usage, operands are either read from, written to, or read from and written to the TR1 context register file 125₁. In pipeline fashion, further GPT processor packets of 1 to K instructions are fetched and executed for each of the N threads, thereby approximating a IUN allocation of processor resources to each of the N threads in GPT processor.

The CoP 104 comprises a CoP buffer 130 supporting up to L selected CoP instructions, a vector queue dispatch unit 132 having a packet first in first out (FIFO) buffer 133 and a port FIFO buffer 136, a vector execution engine 134, a CoP access port, that comprises a CoP-in path 135, the port first in first out (FIFO) buffer 136, a CoP-out FIFO buffer 137, a CoP-out path 138, and a CoP address and thread identification (ID) path 139, to the N thread context register files (TR1-TRN) 125₁-125_{N}, and a vector memory 140. Generally, on an instruction fetch operation, a cache line is read out on a hit in the Icache 106. The cache line may have a plurality of instruction packets and due to variable packet lengths, the last packet in the cache line can cross over to the next cache line and require another cache line fetch. Once the Icache 106 is read, the cache line is scanned to look for packets identified by the PC address and the packets are then transferred to the instruction queue 110. In this next scenario, one of the packets put into the instruction queue 110 has K+L instructions. The fetched K+L instructions are transferred to one of the N thread queues 111₁, 111₂,-111_{N} in the instruction fetch queue 110. The GPTCoP dispatch unit 112 selects the K+L instructions from the selected N thread queue and dispatches K instructions to GPT processor 102 in GPT buffer 120 and L instructions to the CoP 104 in buffer 130. The vector queue dispatch unit 132 then selects the L instructions from the CoP buffer 130 and dispatches them according to pipeline and hazard selection rules to the vector execution engine 134. According to each instruction's decoded usage, operands may be read from, written to, or read from and written to the N thread context register files (TR1-TRN) 125₁-125_{N}. The transfers from the TR1-TRN register files 125₁-125_{N} utilize a port having CoP-in path 135, the port FIFO buffer 136, a CoP-out FIFO 137, a CoP-out path 138, and a CoP address and thread identification (ID) path 139. In pipeline fashion, further CoP processor packets of 1 to L instructions are fetched and executed.

To support a combined GPT processor 102 and CoP 104 operation, and reduce GPT processor interruption for passing variables to the coprocessor, a shared register file technique is utilized. Since each thread in the GPT processor 102 maintains, at least in part, the thread context in a thread register file, there are N thread context register files (TR1-TRN) 125₁-125_{N}, each of which may share variables with the coprocessor. A data port on each of the thread register files is assigned to the coprocessor providing a CoP access port 135-138 allowing the accessing of variables to occur without affecting operations on any thread executing on the GPT processor 102. The data port on each of the thread register files is separately accessible by the CoP 104 without interfering with other data accesses by the GPT processor 102. For example, a data value may be accessed from a thread context register file by an insert instruction which executes on the CoP 104. The insert instruction identifies which thread context to select and a register address at which to select the data value. The data value is then transferred to the CoP 104 across the CoP-in path 135 to the port FIFO 136 which associates the data value with the appropriate instruction in the packet FIFO buffer 133. Also, a data value may be loaded to a thread context register by execution of a return data instruction. The return data instruction identifies the thread context and the register address at which to load the data value. The data value is transferred to a return data FIFO 137 and from there to the selected thread context register file.

In FIG. 1, the execution units 124₁ and 124₂ may execute load instructions, store instructions or both load and store instructions in each execution unit. The vector memory 140 is accessible by the GPT processor 102 using load and store instructions which operate across the port having the CoP-in path 135, the port FIFO buffer 136, the CoP-out FIFO 137, the CoP-out path 138, and the CoP address and thread identification (ID) path 139. For a GPT processor 102 load operation, a load address and a thread ID is passed from the execution unit 124₁, for example, to the CoP address and thread ID path 139 to the instruction dispatch unit 132. Load data at the requested load address is accessed from the vector memory 140 and passed through the CoP-out FIFO 137 to the appropriate thread register file identified by the thread ID associated with this vector memory access.

For a GPT processor 102 store operation, a store address and a thread ID is passed from the execution unit 124₁, for example, to the CoP address and thread ID path 139 to the instruction dispatch unit 132. Data accessed from a thread register file is accessed and passed to the CoP-in path 135 to instruction dispatch unit 132. The store data is then stored in the vector memory 140 at the store address. Sufficient bandwidth is provided on the shared port between the GPT processor 102 and the CoP 104 to support execution of two load instructions, two store instructions, and a load instruction and a store instruction.

Data may be cached in the L1 Data cache 126 and in the L2 cacheTCM from the vector memory 140. Coherency is maintained between the two memory systems by software means or hardware means or a combination of both software and hardware means. For example, vector data may be cached in the L1 data cache 126, then operated on by the GPT processor 102, and then moved back to the vector memory 140 prior to enabling the vector processor 104 to operate on the data that was moved. A real time operating system (RTOS) may provide such means enabling flexibility of processing according to the capabilities of the GPT processor 102 and the CoP 104.

FIG. 2A illustrates an embodiment for a process 200 of fetching instructions, identifying instruction packets, and loading coded instruction packets into an instruction queue that may be advantageously employed. In process 200, packets for an exemplary thread A are processed with a queue supporting KI only instruction packets, LI only instruction packets, or KI & LI instruction packets. Packets stored in the queue also include a packet header indicating the type of packet as described in more detail below. A processor, such as the GPT processor 102 of FIG. 1, supplies a fetch address and initiates the process 200. At block 204, a block of instructions including the instruction at the fetch address is fetched from the Icache 106 on a hit in the Icache 106 or from the memory hierarachy 108. A block of instructions may be associated with a plurality of packets fetched from a cache line and contain a mix of instructions from different threads. In the example scenario of FIG. 2A, a fetched packet is associated with thread A. At block 206, a determination is made whether the selected packet for thread A is coprocessor related or not. For example, a CoP bit in a register may be evaluated to identify that the selected instruction packet is a coprocessor related packet or that it is not coprocessor related. The CoP bit may be set in the register in response to a real time operating system (RTOS) directive. If the determination indicates the selected packet is not coprocessor related, the process 200 proceeds to block 210. At block 210, the instruction packet containing up to K GPT processor instructions (1≦K≦J), along with a packet header field indicating the packet contains KI only instructions, is stored in an available thread queue such as TQ2 111₂ of FIG. 1. A thread queue is determined to be available based on whether a queue associated with a thread of the selected packet has capacity to store the packet. The packet header field may be a two bit field stored in a header associated with the selected packet indicating the type of packet such as a KI, an LI, or other packet type specified by the architecture. As one example, a 2-bit packet header field is advantageously employed for fast decoding when packets are selected for dispatching as described in more detail with regard to FIG. 2E. A thread that is coprocessor related may include instruction packets that are only GPT processor KI only type instructions, a mix of KI and LI instructions, or may be coprocessor LI only type instructions. For example, if a scalar constant is required in order to execute specific coprocessor instructions and the scalar constant is based on current operating state, GPT processor KI only instructions for execution on the GPT processor 102 may be used to generate the scalar value. The generated scalar value would be stored in one of the TR1-TRN register files 125₁-125_{N} and shared through the CoP-in path 135 to the coprocessor. The process 200 then returns to block 204.

Returning to block 206, where a determination is made that indicates the selected packet is coprocessor related, the process 200 proceeds to block 208. At block 208, a determination is made whether the instruction packet is a KI only packet (1≦K≦J). If the packet is a KI only packet, the process 200 proceeds to block 210 and the packet header is set to indicate the packet contains KI only instructions. At block 208, if the determination indicates the packet is not a KI only packet, the process 200 proceeds to block 212. At block 212, a determination is made whether the packet is LI only (1≦L≦J) or a KI and LI packet (1≦(K+L)≦J). If the packet is a KI and LI packet, the process 200 proceeds to block 214, in which KI instructions and LI instructions are split from the packet. The KI instructions split from the packet are transferred to block 210 and a header of “1” for a KI & LI packet along with the KI instructions are stored in an available thread queue. The LI instructions are transferred to block 216 and a header of “11” for a KI & LI packet along with the LI instructions are stored in an available thread queue. Returning to block 212, where a determination is made that the packet is LI only, and the process 200 proceeds to block 216. At blocks 210 and 216, an appropriate packet header field, “01” KI only, “10” LI only, or “11” KI and LI along with the corresponding selected instruction packet is stored in an available thread queue, such as TQ1 111₁ of FIG. 1. The process 200 then returns to block 204.

FIG. 2B illustrates an embodiment for a process 220 of fetching instructions, identifying instruction packets, and loading coded instruction packets into an instruction queue for two threads that may be advantageously employed. In process 220, packets for two exemplary threads, thread A and thread B, are processed with a queue associated with each thread. In the example scenario of FIG. 2B, one of the fetched packets is associated with thread A and another packet is associated with thread B. A plurality of fetched packets, such as the thread A packet and the thread B packet, and their associated packet headers identifying the packet type, are distributed by the store thread selector (STS) 109. For example, one packet for one thread is fetched per cycle and the packet is processed as described in FIG. 2A. The destination as to which Buffer the packet is transferred to is determined based on a thread ID.

The process 220 for thread A operates as described with regard to FIG. 2A. The process for thread B operates in a similar manner to the process 200 for thread A. In particular, for thread B at block 206, a determination is made whether the selected packet for thread B is coprocessor related or not. If the determination indicates the selected packet is not coprocessor related, the process 220 proceeds to block 221. At block 221, a determination is made whether the packet is for thread A. In this exemplary scenario, the packet is a thread B packet and the process 220 proceeds to block 222. At block 222, the instruction packet containing the up to K GPT processor instructions (1≦K≦J), along with a packet header field is stored in an available thread queue, such as TQ4 111₄ of FIG. 1. The process 220 then returns to block 204.

At block 206, if the determination indicates the selected packet is coprocessor related, the process 220 proceeds to block 208. At block 208, a determination is made whether the instruction packet is a KI only packet (1≦K≦J). If the determination indicates the selected packet is a KI only packet, the process 220 proceeds to block 221 and then to block 222 for the thread B packet. If the packet is not a KI only packet, the process 220 proceeds to block 212. At block 212, a determination is made whether the packet is LI only (1≦L≦J). If the determination indicates the selected packet is an LI only packet, the process 220 proceeds to block 223. At block 223, a determination is made based on the thread ID. For the thread B packet, the process 220 proceeds to block 224. If the determination at block 212 indicates the selected packet is a KI and LI packet (I≦(K+L)≦J), the process 220 proceeds to block 214. At block 214, the KI instructions and the LI instructions are split from the packet and the KI instructions are delivered to block 225 and the LI instructions are delivered to block 226. The decision blocks 225 and 226 determine for the thread B packet to send the KI instructions to block 222 and the LI instructions to block 224. At block 224, an appropriate packet header field, “10” LI only or “11” KI and LI along with the selected LI instruction packet is stored in an available thread queue, such as IQ3 111₃ of FIG. 1. The process 220 then returns to block 204. In the process 220, the process associated with thread A and the process associated with thread B may be operated in a sequential manner or in parallel to process a packet for both thread A and for thread B, for example by duplicating the process steps 206, 208, 212, and 214 and adjusting the thread distribution blocks 221, 223, 225, and 226 appropriately.

FIG. 2C illustrates another embodiment for a process 230 of fetching instructions, identifying instruction packets, and loading coded instruction packets into an instruction queue for a single thread that may be advantageously employed. In the process 230, blocks 206, 208, and 212 determine the setting for the packet header to be stored in a queue for the packet in block 232 with the fetched instruction packet stored in the same queue at block 234. At block 206, if the coprocessor bit is not set the process 230 proceeds to block 232 where the header is set to 01 for a KI only instruction packet. At block 206 and the coprocessor bit set, the process 230 proceeds to block 208. At block 208, if the packet is determined to be a KI only packet, the process 230 proceeds to block 232 where the packet header set to 01 for the KI only instruction packet. Returning to block 208, if the packet is determined to not be a KI only packet, the process 230 proceeds to block 212. At block 212, if the packet is determined to be a LI only packet, the process 230 proceeds to block 232 where the packet header is set to 10 for the LI only instruction packet. Returning to block 212, if the packet is determined to be a mixed packet of KI and LI instructions, the process 230 proceeds to block 232 where the packet header is set to 11 for the KI and LI instruction packet. As noted above, the fetched instruction packet stored in the same queue at block 234 and with the packet header that was set at block 232.

FIG. 2D illustrates another embodiment 240 for a process of fetching instructions, identifying instruction packets, and loading coded instruction packets into an instruction queue for two threads that may be advantageously employed. The process 240 is similar to the process 220 of FIG. 2B with the distinction of determining the thread queue destination at block 245, storing the fetched instruction packet for thread A at block 246 and for thread B at block 247, creating a header for the packet at block 241, and subsequent storing of the header with the thread A packet at block 243 and with the thread B packet at block 244. In particular, a fetched instruction packet is evaluated at block 206 to determine if the coprocessor bit is set. If the coprocessor bit is not set, the process 240 proceeds to block 241 since the instruction packet is made up of KI only instructions and at block 241, a header of 01 is created. At block 206, if the coprocessor bit is set, the process 240 proceeds to block 208 where a determination is made whether the packet is also a KI only packet. At block 208, if the determination indicates the packet is KI only, the process 240 proceeds to block 241 where a header of 01 is created. At block 208, if the determination indicates the packet is not KI only, the process 240 proceeds to block 212. At block 212, a determination is made whether the packet is LI only. If the packet is LI only, the process 240 proceeds to block 241 where a header of 10 is created. At block 212, if the determination indicates the packet is not LI only, the process 240 proceeds to block 241 where a header of 11 is created.

The process 240 then proceeds to block 242 where a determination of the thread destination is made. At block 242, if the determination indicates the packet is for thread A, the process 240 proceeds to block 243 where the header is inserted with the instruction packet in a thread A queue. At block 242, if the determination indicates the packet is for thread B, the process 240 proceeds to block 244 where the header is inserted with the instruction packet in a thread B queue. Also, at block 245, the fetched instruction packet is determined whether it is a thread A packet or a thread B packet. For a packet determined to be for thread A, the fetched packet is stored in a thread A queue at block 246 and for a packet determined to be for thread B, the fetched packet is stored in a thread B queue at block 247. The process 240 then returns to block 204.

FIG. 2E illustrates an embodiment for a process 250 of dispatching instructions to a first processor and to a second processor that may be advantageously employed. A dispatch unit, such as the GPTCoP dispatch unit 112 of FIG. 1, selects a thread queue, one of the plurality of thread queues 111₁, 111₂, . . . 111_{N}, and instructions from the selected thread queue are dispatched to the GPT processor 102, the CoP 104, or to both the GPT processor 102 and the CoP 104 according to the process 250. At block 252, priority thread instruction packets including packet headers are read according to blocks 254-257 associated with the IQ 110 of FIG. 1. For example, in one embodiment, the header 254 and instruction packet 255 for thread A correspond to blocks 210 and 216 of FIG. 2B. The header 256 and instruction packet 257 for thread B correspond to blocks 222 and 224 of FIG. 2B. In another embodiment, the header 254 and instruction packet 255 for thread A correspond to blocks 243 and 246 of FIG. 2D. The header 256 and instruction packet 257 for thread B correspond to blocks 244 and 247 of FIG. 2D. Thread priority 258 is an input to block 252. The thread queues are selected by a read thread selector (RTS) 114 in the GPTCoP dispatch unit 112. Threads are selected according to a selection rule, such as round robin, or demand based, or the like with constraints such as preventing starvation, such as never accessing a particular thread queue, for example.

At block 260 a determination is made whether thread A has priority or if thread B has priority. If the determination indicates thread A has priority, the process 250 proceeds to block 262. At block 262, a determination is made whether the packet is coprocessor related or not. If the determination indicates the packet is not coprocessor related, then the packet has KI only instructions and the process 250 proceeds to block 264. At block 264, a determination is made whether there is an LI only packet in thread B available to be issued. If the determination indicates that there is no LI only thread B packet available, the process 250 proceeds to block 266. At block 266, the KI only instructions are dispatched to the GPT processor for execution. The process 250 then returns to block 252. If the determination at block 264 indicates that there is an LI only thread B packet available, the process 250 proceeds to block 274. At block 274, the KI only instructions from thread A are dispatched to the GPT processor for execution and in parallel the LI only instructions from thread B are dispatched to the CoP for execution. The process 250 then returns to block 252.

Returning to block 262, if the determination at block 262 indicates the packet is coprocessor related, then the packet may be KI only instructions, LI only instructions or KI and LI instructions and the process 250 proceeds to block 268. At block 268, a determination is made whether the thread A packet is KI only. If the determination indicates the packet is KI only, the process 250 proceeds to block 264. At block 264, a determination is made whether there is an LI only packet in thread B available to be issued. If the determination indicates that there is no LI only thread B packet available, the process 250 proceeds to block 266. At block 266, the KI only instructions are dispatched to the GPT processor for execution. The process 250 then returns to block 252. If the determination at block 264 indicates that there is an LI only thread B packet available, the process 250 proceeds to block 274. At block 274, the KI only instructions from thread A are dispatched to the GPT processor for execution and in parallel the LI only instructions from thread B are dispatched to the CoP for execution. The process 250 then returns to block 252. Returning to block 268, where a determination indicates the packet is not KI only and the process 250 proceeds to block 270. At block 270, a determination is made whether the thread A packet is LI only or a KI and LI instruction packet. If the determination indicates the packet is a KI and LI instruction packet, the process 250 proceeds to block 272. At block 272, the packet is split into a KI only group of instructions and an LI only group of instructions. At block 274, the KI only instructions from thread A are dispatched to the GPT processor for execution and in parallel the LI only instructions from thread A are dispatched to the CoP for execution. The process 250 then returns to block 252. If the determination at block 270 indicates the packet is an LI only packet, the process 250 proceeds to block 276. At block 276, a determination is made whether there is a KI only packet in thread B available to be issued. If the determination indicates that there is no KI only thread B packet available, the process 250 proceeds to block 278. At block 278, the thread A LI only instructions are dispatched to the CoP for execution. The process 250 then returns to block 252. If the determination at block 276 indicates that there is a KI only thread B packet available, the process 250 proceeds to block 274. At block 274, the LI only instructions from thread A are dispatched to the CoP for execution and in parallel the KI only instructions from thread B are dispatched to the GPT processor for execution. The process 250 then returns to block 252.

Returning to block 260 a determination is made which indicates thread B has priority, the process 250 proceeds to block 280. At block 280, a determination is made whether the packet is coprocessor related or not. If the determination indicates the packet is not coprocessor related, then the packet has KI only instructions and the process 250 proceeds to block 282. At block 282, a determination is made whether there is an LI only packet in thread A available to be issued. If the determination indicates that there is no LI only thread A packet available, the process 250 proceeds to block 266. At block 266, the KI only instructions are dispatched to the GPT processor for execution. The process 250 then returns to block 252. If the determination at block 282 indicates that there is an LI only thread A packet available, the process 250 proceeds to block 274. At block 274, the KI only instructions from thread B are dispatched to the GPT processor for execution and in parallel the LI only instructions from thread A are dispatched to the CoP for execution. The process 250 then returns to block 252.

Returning to block 280, if the determination at block 280 indicates the packet is coprocessor related, then the packet may be KI only instructions. LI only instructions or KI and LI instructions and the process 250 proceeds to block 283. At block 283, a determination is made whether the thread B packet is KI only. If the determination indicates the packet is KI only, the process 250 proceeds to block 282. At block 282, a determination is made whether there is an LI only packet in thread A available to be issued. If the determination indicates that there is no LI only thread A packet available, the process 250 proceeds to block 266. At block 266, the KI only instructions are dispatched to the GPT processor for execution. The process 250 then returns to block 252. If the determination at block 282 indicates that there is an LI only thread A packet available, the process 250 proceeds to block 274. At block 274, the KI only instructions from thread B are dispatched to the GPT processor for execution and in parallel the LI only instructions from thread A are dispatched to the CoP for execution. The process 250 then returns to block 252. Returning to block 283, where a determination indicates the packet is not KI only and the process 250 proceeds to block 284. At block 284, a determination is made whether the thread B packet is LI only or a KI and LI instruction packet. If the determination indicates the packet is a KI and LI instruction packet, the process 250 proceeds to block 286. At block 286, the packet is split into a KI only group of instructions and an LI only group of instructions. At block 274, the KI only instructions from thread B are dispatched to the GPT processor for execution and in parallel the LI only instructions from thread B are dispatched to the CoP for execution. The process 250 then returns to block 252. If the determination at block 284 indicates the packet is an LI only packet, the process 250 proceeds to block 288. At block 288, a determination is made whether there is a KI only packet in thread A available to be issued. If the determination indicates that there is no KI only thread A packet available, the process 250 proceeds to block 278. At block 278, the thread B LI only instructions are dispatched to the CoP for execution. The process 250 then returns to block 252. If the determination at block 288 indicates that there is a KI only thread A packet available, the process 250 proceeds to block 274. At block 274, the LI only instructions from thread B are dispatched to the CoP for execution and in parallel the KI only instructions from thread A are dispatched to the GPT processor for execution. The process 250 then returns to block 252.

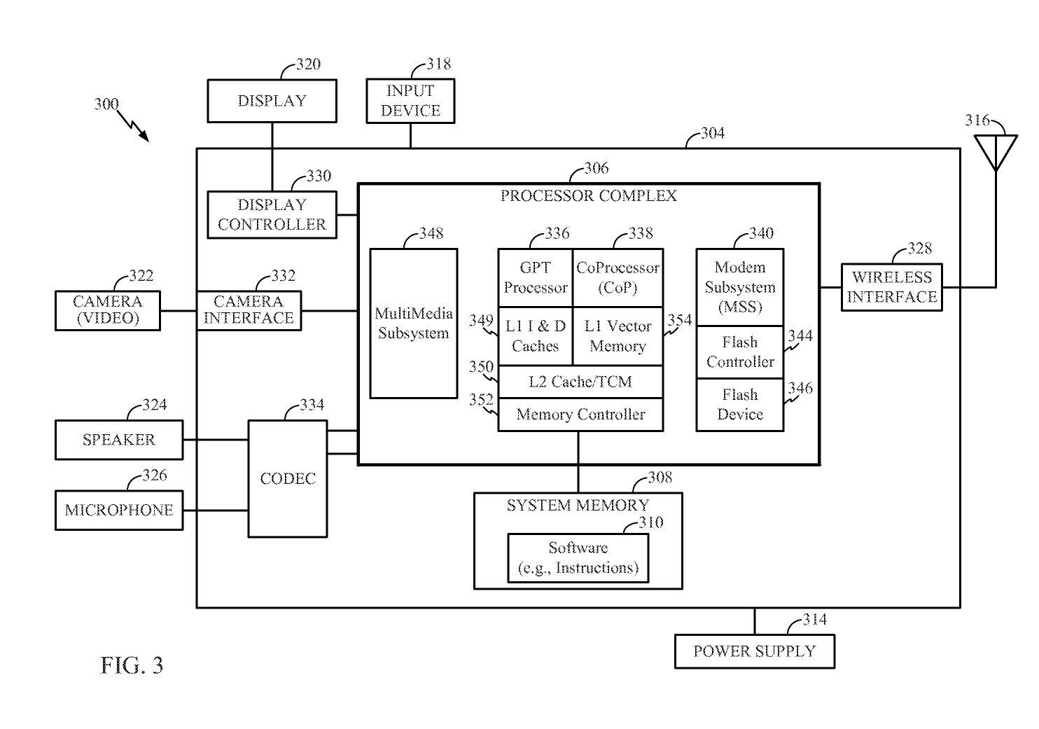

FIG. 3 illustrates a portable device 300 having a GPT processor 336 and coprocessor 338 system that is configured to meet real time requirements of the portable device. The portable device 300 may be a wireless electronic device and include a system core 304 which includes a processor complex 306 coupled to a system memory 308 having software instructions 310. The portable device 300 comprises a power supply 314, an antenna 316, an input device 318, such as a keyboard, a display 320, such as a liquid crystal display LCD, one or two cameras 322 with video capability, a speaker 324 and a microphone 326. The system core 304 also includes a wireless interface 328, a display controller 330, a camera interface 332, and a codec 334. The processor complex 306 includes a dual core arrangement of a general purpose thread (GPT) processor 336 having a local level 1 instruction cache and a level 1 data cache 349 and coprocessor (CoP) 338 having a level 1 vector memory 354. The GPT processor 336 may correspond to the GPT processor 102 and the CoP 338 may correspond to the CoP 104, both of which operate as described above in connection with the discussion of FIG. 1 and FIGS. 2A-2C. The processor complex 306 may also include a modem subsystem 340, a flash controller 344, a flash device 346, a multimedia subsystem 348, a level 2 cache/TCM 350, and a memory controller 352. The flash device 346 may suitably include a removable flash memory or may also be an embedded memory.

In an illustrative example, the system core 304 operates in accordance with any of the embodiments illustrated in or associated with FIGS. 1 and 2. For example, as shown in FIG. 3, the GPT processor 336 and CoP 338 are configured to access data or program instructions stored in the memories of the L1 I & D caches 349, the L2 cache/TCM 350, and in the system memory 308 to provide data transactions as illustrated in FIG. 2A-2C. The L1 instruction cache of the L1 I & D caches 349 may correspond to the instruction cache 106 and the L2 cache/TCM 350 and system memory 308 may correspond to the memory hierarchy 108. The memory controller 352 may include the instruction fetch queue 110 and the GPTCoP dispatch unit 112 which may operate as described above in connection with the discussion of FIG. 1 and FIGS. 2A-2C. For example, the instruction fetch queue 110 of FIG. 1 and the process of fetching instructions, identifying instruction packet, and loading coded instruction packets into the instruction queue according to the process illustrated in FIG. 2A describe an exemplary means for storing instructions associated with a specific thread of instructions in an instruction fetch queue (IFQ) in order for the instructions to be accessible for transfer to a processor associated with the thread. Also, the GPTCoP dispatch unit 112 of FIG. 1 and the process of dispatching instructions to a first processor and to a second processor according to the process illustrated in FIG. 2B describe an exemplary means for selecting a first packet of thread instructions from the IFQ and a second packet of coprocessor instructions from the IFQ and sending the selected first packet to a threaded processor and the selected second packet to the coprocessor in parallel.

The wireless interface 328 may be coupled to the processor complex 306 and to the wireless antenna 316 such that wireless data received via the antenna 316 and wireless interface 328 can be provided to the MSS 340 and shared with CoP 338 and with the GPT processor 336. The camera interface 332 is coupled to the processor complex 306 and is also coupled to one or more cameras, such as a camera 322 with video capability. The display controller 330 is coupled to the processor complex 306 and to the display device 320. The coder/decoder (Codec) 334 is also coupled to the processor complex 306. The speaker 324, which may comprise a pair of stereo speakers, and the microphone 326 are coupled to the Codec 334. The peripheral devices and their associated interfaces are exemplary and not limited in quantity or in capacity. For example, the input device 318 may include a universal serial bus (USB) interface or the like, a QWERTY style keyboard, an alphanumeric keyboard, and a numeric pad which may be implemented individually in a particular device or in combination in a different device.

The GPT processor 336 and CoP 338 are configured to execute software instructions 310 that are stored in a non-transitory computer-readable medium, such as the system memory 308, and that are executable to cause a computer, such as the dual core processors 336 and 338, to execute a program to provide data transactions as illustrated in FIGS. 2A and 2B. The GPT processor 336 and the CoP 338 are configured to execute the software instructions 310 that are accessed from the different levels of cache memories, such as the L1 instruction cache 349, and the system memory 308.

In a particular embodiment, the system core 304 is physically organized in a system-in-package or on a system-on-chip device. In a particular embodiment, the system core 304, organized as a system-on-chip device, is physically coupled, as illustrated in FIG. 3, to the power supply 314, the wireless antenna 316, the input device 318, the display device 320, the camera or cameras 322, the speaker 324, the microphone 326, and may be coupled to a removable flash device 346.

The portable device 300 in accordance with embodiments described herein may be incorporated in a variety of electronic devices, such as a set top box, an entertainment unit, a navigation device, a communications device, a personal digital assistant (PDA), a fixed location data unit, a mobile location data unit, a mobile phone, a cellular phone, a computer, a portable computer, tablets, a monitor, a computer monitor, a television, a tuner, a radio, a satellite radio, a music player, a digital music player, a portable music player, a video player, a digital video player, a digital video disc (DVD) player, a portable digital video player, any other device that stores or retrieves data or computer instructions, or any combination thereof.

The various illustrative logical blocks, modules, circuits, elements, or components described in connection with the embodiments disclosed herein may be implemented or performed with a general purpose processor, a digital signal processor (DSP), an application specific integrated circuit (ASIC), a field programmable gate array (FPGA) or other programmable logic components, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, for example, a combination of a DSP and a microprocessor, a plurality of microprocessors, one or more microprocessors in conjunction with a DSP core, or any other such configuration appropriate for a desired application.

The GPT processor 102, the CoP 108 of FIG. 1 or the dual core processors 336 and 338 of FIG. 3, for example, may be configured to execute instructions to allow preempting a data transaction in the multiprocessor system in order to service a real time task under control of a program. The program stored on a computer readable non-transitory storage medium either directly associated locally with processor complex 306, such as may be available through the instruction cache 349, or accessible through a particular input device 318 or the wireless interface 328. The input device 318 or the wireless interface 328, for example, also may access data residing in a memory device either directly associated locally with the processors, such as the processor local data caches, or accessible from the system memory 308. The methods described in connection with various embodiments disclosed herein may be embodied directly in hardware, in a software module having one or more programs executed by a processor, or in a combination of the two. A software module may reside in random access memory (RAM), dynamic random access memory (DRAM), synchronous dynamic random access memory (SDRAM), flash memory, read only memory (ROM), erasable programmable read only memory (EPROM), electrically erasable programmable read only memory (EEPROM), hard disk, a removable disk, a compact disk (CD)-ROM, a digital video disk (DVD) or any other form of non-transitory storage medium known in the art. A non-transitory storage medium may be coupled to the processor such that the processor can read information from, and write information to, the storage medium. In the alternative, the storage medium may be integral to the processor.

While the invention is disclosed in the context of illustrative embodiments for use in processor systems, it will be recognized that a wide variety of implementations may be employed by persons of ordinary skill in the art consistent with the above discussion and the claims which follow below. For example, a fixed function implementation may also utilize various embodiments of the present invention.

What is claimed is:

1. A method for parallel dispatch of coprocessor instructions to a coprocessor and threaded processor instructions to a threaded processor, the method comprising:
accessing a first packet of threaded processor instructions from an instruction fetch queue (IFQ);
accessing a second packet of coprocessor instructions from the IFQ; and
dispatching the first packet to the threaded processor and the second packet to the coprocessor in parallel.

2. The method of claim 1, wherein the first packet contains the threaded instructions in a first fetch buffer in the IFQ and the second packet contains the coprocessor instructions in a second fetch buffer in the IFQ.

3. The method of claim 1, wherein the first packet contains the threaded instructions in a first fetch buffer in the IFQ and the second packet contains the coprocessor instructions in the first fetch buffer, wherein the first fetch buffer contains a mix of threaded instructions and coprocessor instructions.

4. The method of claim 1, wherein the threaded processor is a general purpose threaded (GPT) processor supporting multiple threads of execution and the second processor is a single instruction multiple data (SIMD) vector processor.

5. The method of claim 1, wherein at least one thread register file is configured with a data port assigned to the coprocessor allowing the accessing of variables stored in the thread register file to occur without affecting operations on any thread executing on the threaded processor.

6. The method of claim 1 further comprising:
generating a first header containing a first logic code for a first packet fetched from memory, wherein the logic code identifies the fetched first packet as the first packet of threaded processor instructions;
generating a second header containing a second logic code for a second packet fetched from memory, wherein the second logic code identifies the fetched second packet as the second packet of coprocessor instructions;
storing the first header and first packet in a first available thread queue in the IFQ; and
storing the second header and second packet in a second available thread queue in the IFQ.

7. The method of claim 6 further comprising:
dispatching the first packet to the threaded processor and the second packet to the coprocessor based on the logic code of each associated packet.

8. The method of claim 1 further comprising:
fetching from an instruction memory a third packet of instructions that contains at least one threaded processor instruction and at least one coprocessor instruction;
splitting the at least one threaded processor instruction from the fetched packet for storage as the first packet in the IFQ; and
splitting the at least one coprocessor instruction from the fetched packet for storage as the second packet in the IFQ.

9. An apparatus for parallel dispatch of coprocessor instructions to a coprocessor and threaded processor instructions to a threaded processor, the apparatus comprising:
an instruction fetch queue (IFQ) comprising a plurality of thread queues that are configured to store instructions associated with a specific thread of instructions; and
a dispatch circuit configured for selecting a first packet of thread instructions from the IFQ and a second packet of coprocessor instructions from the IFQ and sending the selected first packet to a threaded processor and the selected second packet to the coprocessor in parallel.

10. The apparatus of claim 9, wherein the IFQ further comprises:
a store thread selector that is configured to select an available first thread queue for storing the first packet and to select an available second thread queue for storing the second packet.

11. The apparatus of claim 10, wherein the dispatch circuit comprises:
a read thread selector that is configured to select the first thread queue to read the first packet and to select the second thread queue to read the second packet and then dispatching the first packet and the second packet in parallel.

12. The apparatus of claim 9 further comprising:
a data port between the coprocessor and at least one thread register file of a plurality of thread register files in the threaded processor, wherein a register in a selected thread register file in the threaded processor is shared through the data port without affecting operations on any thread executing on the threaded processor.

13. The apparatus of claim 9 further comprising:
a data port configured to store a data value read from a threaded processor register file in a store buffer in the coprocessor, wherein the data value is associated with a coprocessor instruction requesting the data value.

14. The apparatus of claim 9 further comprising:
a data port configured to store a data value generated by the coprocessor in a register file in the threaded processor.

15. A method for parallel dispatch of coprocessor instructions to a coprocessor and threaded processor instructions to a threaded processor, the method comprising:
fetching a first packet of instructions from a memory, wherein the fetched first packet contains at least one threaded processor instruction and at least one coprocessor instruction;
splitting the at least one threaded processor instruction from the fetched first packet as a threaded processor instruction packet;
splitting the at least one coprocessor instruction from the fetched first packet as a coprocessor instruction packet; and
dispatching the threaded processor instruction packet to the threaded processor and in parallel the coprocessor instruction packet to the coprocessor.

16. The method of claim 15, wherein the splitting of the at least one threaded processor instruction and the splitting of the at least one coprocessor from the fetched first packet occurs prior to dispatching the threaded processor instruction packet and the coprocessor instruction packet to their respective destination processor.

17. The method of claim 15, wherein the splitting of the at least one threaded processor instruction and the splitting of the at least one coprocessor from the fetched first packet occurs on storage of the threaded processor instruction packet and the coprocessor instruction packet in an instruction queue.

18. The method of claim 15, wherein the fetched first packet contains at least one threaded processor instruction and a plurality of coprocessor instructions.

19. The method of claim 15, wherein a second packet following the fetched first packet contains at least one coprocessor instruction and a plurality of threaded processor instructions.

20. The method of claim 15 further comprising:
fetching the first packet of instructions from an instruction cache memory hierarchy; and
storing the fetched first packet through a store thread selector configured to access the threaded processor instruction queue and the coprocessor instruction queue.

21. The method of claim 20, wherein the threaded processor instruction queue and the coprocessor instruction queue are selected from a plurality of thread queues based on a thread priority and available capacity in a selected thread queue.

22. An apparatus for parallel dispatch of coprocessor instructions to a coprocessor and threaded processor instructions to a threaded processor, the apparatus comprising:
a memory from which a packet of instructions is fetched, wherein the packet contains at least one threaded processor instruction and at least one coprocessor instruction;
a store thread selector (STS) configured to receive the packet of instructions, determine a header indicating type of instructions that comprise the packet, and store the instructions from the packet and the header in an instruction queue; and
a dispatch unit configured to select the threaded processor instruction and send the threaded processor instruction to the threaded processor and in parallel select the coprocessor instruction and send the coprocessor instruction to the coprocessor.

23. The apparatus of claim 22, wherein the STS is configured to split the at least one threaded processor instruction from the fetched packet for storage as a threaded processor instruction packet in a threaded processor instruction queue and split the at least one coprocessor instruction from the fetched packet for storage as a coprocessor instruction packet in a coprocessor instruction queue.

24. The apparatus of claim 22, wherein the memory is part of an instruction cache memory hierarchy and the STS is configured to access the threaded processor instruction queue and access the coprocessor instruction queue.

25. The apparatus of claim 23, wherein the threaded processor instruction queue and the coprocessor instruction queue are selected from a plurality of thread queues based on a thread priority and available capacity in a selected thread queue.

26. A computer readable non-transitory medium encoded with computer readable program data and code, the program data and code when executed operable to:
access a first packet of threaded processor instructions from an instruction fetch queue (IFQ):
access a second packet of coprocessor instructions from the IFQ; and
dispatch the first packet to the threaded processor and the second packet to the coprocessor in parallel.

27. An apparatus for parallel dispatch of coprocessor instructions to a coprocessor and threaded processor instructions to a threaded processor, the apparatus comprising:
means for storing instructions associated with a specific thread of instructions in an instruction fetch queue (IFQ) in order for the instructions to be accessible for transfer to a processor associated with the thread; and
means for selecting a first packet of thread instructions from the IFQ and a second packet of coprocessor instructions from the IFQ and sending the selected first packet to a threaded processor and the selected second packet to the coprocessor in parallel.

28. A computer readable non-transitory medium encoded with computer readable program data and code, the program data and code when executed operable to:
fetch a first packet of instructions from a memory, wherein the fetched first packet contains at least one threaded processor instruction and at least one coprocessor instruction;
split the at least one threaded processor instruction from the fetched first packet as a threaded processor instruction packet;
split the at least one coprocessor instruction from the fetched first packet as a coprocessor instruction packet; and
dispatch the threaded processor instruction packet to the threaded processor and in parallel dispatch the coprocessor instruction packet to the coprocessor.

29. An apparatus for parallel dispatch of coprocessor instructions to a coprocessor and threaded processor instructions to a threaded processor, the apparatus comprising:
means for fetching a packet of instructions, wherein the packet contains at least one threaded processor instruction and at least one coprocessor instruction;
means for receiving the packet of instructions, determining a header indicating type of instructions that comprise the packet, and storing the instructions from the packet and the header in an instruction queue; and
means for selecting the threaded processor instruction and sending the threaded processor instruction to the threaded processor and in parallel selecting the coprocessor instruction and sending the coprocessor instruction to the coprocessor.
